(19) United States
(12) Patent Application Publication
(10) Pub. No.: US 2005/0126637 A1
(43) Pub. Date: Jun. 16, 2005

(54) Valve operated by differential pressure

(75) Inventors: Yunggyo Lee, Daejeon (KR); Jinwoo Lee, Daejeon (KR); Dongmin Kim, Daejeon (KR); Wanggu Kang, Daejeon (KR); Sungyuk Kim, Daejeon (KR); Haechang Lee, Daejeon (KR); Chanhong Yeom, Daejeon (KR)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: KOREA AEROSPACE RESEARCH INSTITUTE, Daejeon (KR)

(21) Appl. No.: 10/743,424

(22) Filed: Dec. 23, 2003

(30) Foreign Application Priority Data
Dec. 16, 2003 (KR) 10-2003-0091941

(51) Int. Cl. F16K 17/04

(52) U.S. Cl. 137/529

(57) ABSTRACT

A valve operated by differential pressure according to the present invention comprises a valve body, a valve disk, a central link, a link, an elastic member, a member attracted by a magnet, and the magnet; the valve disk being mounted on the valve body, the central link being connected at one end to the valve disk, and opening and closing the valve, the link being connected pivotally at one end to the central link, and making the central link move according to rotation of the link around a link pivot, the elastic member being connected pivotally at one end to the link and fixed pivotally at the other end, and making the link rotate around the link pivot by elastic force of the elastic member, the member being mounted on the other end of the central link, the magnet lying adjacent to the member; the valve being closed tightly without leakage of internal fluid until a predetermined differential pressure is reached, then being opened to the maximum stroke thereof as soon as the predetermined differential pressure is reached, and then being closed again instantly and tightly when the differential pressure is decreased without leakage of internal fluid, by attractive force of the magnet together with elastic force of the elastic member.

### FIELD OF THE INVENTION

The present invention is related to a valve, and more particularly to a valve operated by differential pressure.

### PRIOR ART

A valve operated by differential pressure used for a pressurization system in an unmanned airship that works even over the altitude of 5 km prevents pressure-increase in the airship according to altitude-increase and maintains constant internal pressure by automatic opening and closing operation of the valve.

The valve should be closed tightly without leakage of air or helium gas until a predetermined differential pressure is reached, then opened to the maximum stroke thereof as soon as the predetermined differential pressure is reached, and then closed again tightly without the leakage. Thus, leakage-loss of air or helium gas can be prevented.

Referring to FIGS. 1 and 2, a conventional valve operated by differential pressure used for a pressurization system in an unmanned airship comprises a valve body 10, a valve disk 20, a central link 30, a link 40 and a spring 50.

The conventional valve further comprises a gasket 15 located between the valve body 10 and the valve disk 20. Connecting members 25, 35, 45 pivotally connect the valve disk 20 with the central link 30, the central link 30 with the link 40, and the link 40 with the spring 50 respectively. The spring 50 is pivotally fixed at one end using a spring fixing member 52. The link 40 makes the central link 30 move upward and downward according to rotation of the link 40 around a link pivot 42 supported by a link frame 60. The link frame 60 is supported by a link frame supporting member 70.

When the conventional valve is opened and closed, minute leakage of air or helium gas is inevitable. Furthermore, it was impossible to open the valve to the maximum stroke thereof using only differential pressure without a supply of special power at a predetermined differential pressure. This is because the spring 50 stretches more and more and so elastic force thereof grows bigger and bigger as the valve is getting opened more.

The present invention is devised to solve the above-mentioned problems.

### SUMMARY OF THE INVENTION

An object of the present invention is to provide a valve operated by differential pressure that prevents leakage of fluid when the valve is opened and closed, and that can be opened to the maximum stroke thereof using only differential pressure without a supply of special power.

In order to achieve the object, a valve operated by differential pressure according to the present invention comprises a valve body, a valve disk, a central link, a link, an elastic member, a member attracted by a magnet, and the magnet; the valve disk being mounted on the valve body, the central link being connected at one end to the valve disk, and opening and closing the valve, the link being connected pivotally at one end to the central link, and making the central link move according to rotation of the link around a link pivot, the elastic member being connected pivotally at one end to the link and fixed pivotally at the other end, and making the link rotate around the link pivot by elastic force of the elastic member, the member being mounted on the other end of the central link, the magnet lying adjacent to the member; the valve being closed tightly without leakage of internal fluid until a predetermined differential pressure is reached, then being opened to the maximum stroke thereof as soon as the predetermined differential pressure is reached, and then being closed again instantly and tightly when the differential pressure is decreased without leakage of internal fluid, by attractive force of the magnet together with elastic force of the elastic member.

### BRIEF DESCRIPTION OF THE DRAWINGS

FIG. 1 is a frontal cross sectional view of a conventional valve operated by differential pressure used for a pressurization system in an unmanned airship.

FIG. 2 is a left side cross sectional view of FIG. 1.

FIG. 3 is a frontal cross sectional view of a valve operated by differential pressure used for a pressurization system in an unmanned airship according to an embodiment of the present invention.

FIG. 4 is a left side cross sectional view of FIG. 3.

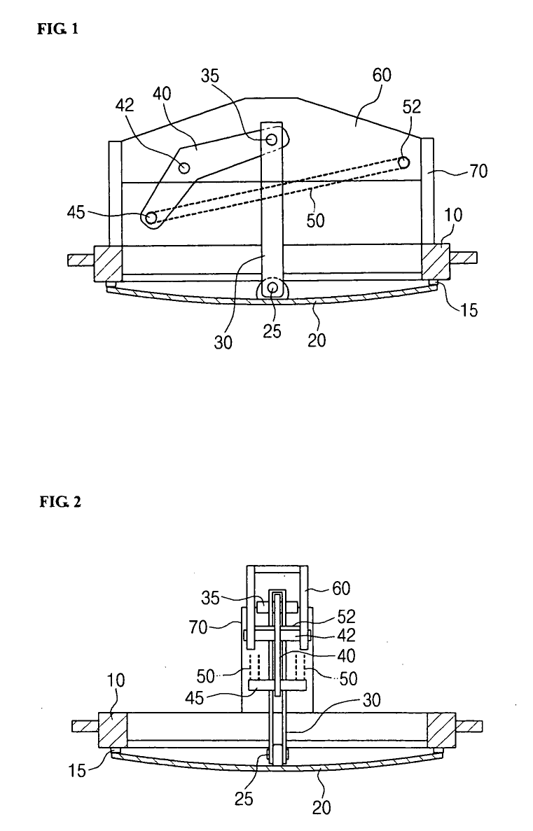

### DETAILED DESCRIPTION OF THE PREFERRED EMBODIMENTS

Hereinafter, referring to the following appended drawings, the preferred embodiments of the present invention will be explained in detail.

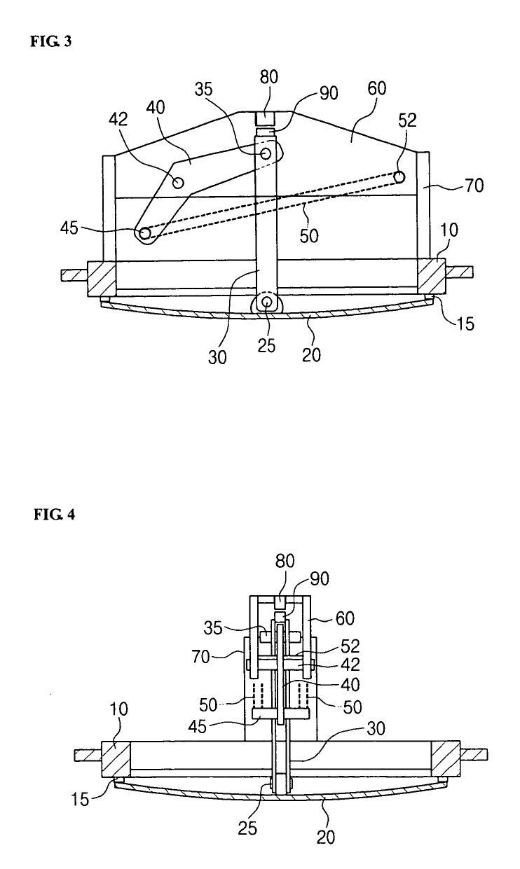

Referring to FIGS. 3 and 4, a valve operated by differential pressure used for a pressurization system in an unmanned airship according to an embodiment of the present invention further comprises a permanent magnet 80 and a member 90 attracted by a magnet in the above-mentioned conventional valve comprising a valve body 10, a valve disk 20, a central link 30, a link 40 and a spring 50.

In the valve, other elements except for the permanent magnet 80 and the member 90 have the same structure with those of the conventional valve. Thus, only the description in relation to the permanent magnet 80 and the member 90 will be done hereinafter.

The member 90 attracted by a magnet is mounted on one end of the central link 30, and the permanent magnet 80 lies adjacent to the member 90. Attractive force between the permanent magnet 80 and the member 90 in addition to elastic force of the spring 50 acts on the valve disk 20 via the central link 30.

The attractive force is inversely proportional to the square of the interval between the permanent magnet 80 and the member 90. That is, as the interval is getting shorter, the attractive force in the direction of closing of the valve is getting larger, and as the interval longer, the attractive force smaller.

When the valve is closed (the interval is preferably 0.05-0.15 mm), the attractive force is maximal, so the valve is not easily opened. As the valve is getting opened more, the attractive force is getting smaller, so it is possible for the valve to be opened to the maximum stroke thereof. As the valve is getting closed more, the attractive force is getting larger, so the valve is easily closed.

Thus, the valve is tightly closed in the initial state, and then it is instantly opened to the maximum stroke thereof when a predetermined differential pressure is reached. The valve is instantly and tightly closed when the differential pressure is decreased. Accordingly, leakage-loss of air or helium gas is prevented when the valve is opened and closed, and internal pressure is easily lowered. Thus, entire operational performance of the valve becomes good.

In case the valve is applied to an unmanned airship, internal pressure of a gas bag is efficiently maintained in a predetermined range when the airship ascends.

The valve used for a pressurization system in an unmanned airship according to an embodiment of the present invention described above has excellences and merits as follows:
firstly, the valve is opened and closed in a state of tight sealing, so leakage-loss of internal gas is prevented and desired internal pressure is easily reached in comparison with a conventional valve using only elastic force of a spring;
secondly, it is economical to use the valve because it uses a cheap and simple part, that is, a permanent magnet; and
thirdly, the valve is effectively operated even in the high altitude because magnetism of the permanent magnet is not reduced in the low temperature.

In the present invention, other elastic members besides the spring 50, other magnets besides the permanent magnet 80 and other internal fluid besides air and helium gas can be used.

Furthermore, the present invention can be applied to all kinds of safety valves operated by differential pressure as an economical and reliable pressure-maintenance means.

The present invention makes it possible to prevent the leakage-loss of internal fluid and reach a desired internal pressure easily using a cheap and simple part, that is, a permanent magnet without a supply of special electric or motive power.

With this description of the invention in detail, those skilled in the art will appreciate that modifications may be made to the invention without departing from the spirit thereof. Therefore, it is not intended that the scope of the invention be limited to the specific embodiment illustrated and described. Rather, it is intended that the scope of the invention be determined by the appended claims.

1. A valve operated by differential pressure, said valve comprising a valve body, a valve disk, a central link, a link, an elastic member, a member attracted by a magnet, and said magnet;
said valve disk being mounted on said valve body, said central link being connected at one end to said valve disk, and opening and closing said valve, said link being connected pivotally at one end to said central link, and making said central link move according to rotation of said link around a link pivot, said elastic member being connected pivotally at one end to said link and fixed pivotally at the other end, and making said link rotate around said link pivot by elastic force of said elastic member, said member being mounted on the other end of said central link, said magnet lying adjacent to said member;
said valve being closed tightly without leakage of internal fluid until a predetermined differential pressure is reached, then being opened to the maximum stroke thereof as soon as the predetermined differential pressure is reached, and then being closed again instantly and tightly when the differential pressure is decreased without leakage of internal fluid, by attractive force of said magnet together with elastic force of said elastic member.

2. A valve according to claim 1 further comprising a gasket located between said valve body and said valve disk.

3. A valve according to claim 1 wherein said elastic member is a spring.

4. A valve according to claim 1 wherein said magnet is a permanent magnet.

5. A valve according to claim 1 wherein the interval between said magnet and said member is 0.05-0.15 mm when said valve is closed.

6. A valve according to claim 1 wherein said valve is used for a pressurization system in an unmanned airship.

7. A valve according to claim 1 wherein said valve is a safety valve.
